(19) United States
(12) Patent Application Publication
(10) Pub. No.: US 2024/0413333 A1
(43) Pub. Date: Dec. 12, 2024

(54) ALL-SOLID-STATE BATTERY FOR PREVENTING DETACHMENT IN ANODE

(71) Applicants: Hyundai Motor Company, Seoul (KR); Kia Corporation, Seoul (KR)

(72) Inventors: Hyun Min Seo, Seoul (KR); Jae Ho Shin, Seoul (KR)

(21) Appl. No.: 18/242,975

(22) Filed: Sep. 6, 2023

(30) Foreign Application Priority Data
Jun. 7, 2023 (KR) 10-2023-0072551

(51) Int. Cl. H01M 4/62; H01M 4/04; H01M 50/566

(52) U.S. Cl. CPC H01M 4/622; H01M 4/0404; H01M 50/566; H01M 2220/20

(57) ABSTRACT

Disclosed is an all-solid-state battery which may prevent detachment in an anode during an ultrasonic-welding process of connecting an anode terminal part to an anode current collector.

### CROSS-REFERENCE TO RELATED APPLICATION

This application claims under 35 U.S.C. § 119 (a) the benefit of priority to Korean Patent Application No. 10-2023-0072551 filed on Jun. 7, 2023, the entire contents of which are incorporated herein by reference.

### TECHNICAL FIELD

The present disclosure relates to an all-solid-state battery which may prevent detachment in an anode during an ultrasonic-welding process of connecting an anode terminal part to an anode current collector.

### BACKGROUND

The process of manufacturing an all-solid-state battery in the related art includes ultrasonically welding a current collector and a terminal part of an electrode using exists. Detachment of the current collector from the electrode in a region adjacent to the terminal part by ultrasonic energy may occur during welding between the current collector and the terminal part.

In order to prevent such detachment, the content of a binder in the electrode may be increased to improve adhesive strength of the current collector to the electrode, but, when the content of the binder is increased, resistance of the electrode is increased, and thus, the output of the battery is reduced.

The above information disclosed in this Background section is only for enhancement of understanding of the background of the invention and therefore it may contain information that does not form the prior art that is already known in this country to a person of ordinary skill in the art.

### SUMMARY

In preferred aspects, the disclosure provides an all-solid-state battery which may prevent detachment in an anode while maintaining cell characteristics.

A term “all-solid-state battery” as used herein refers to a rechargeable secondary battery that includes an electrolyte in a solid state for transferring ions between the electrodes of the battery. In one preferred embodiment, the all-solid-state battery in the disclosure may be anodeless lithium ion battery.

A term “anode-free lithium ion battery,” “anodeless lithium ion battery,” “anode-free battery,” or “anodeless battery” as used herein refers to a lithium ion battery including a bare current collector at its anode side, which is in contrast to a lithium ion battery that uses lithium metal as an anode.

In one aspect, an all-solid-state battery is provided comprising: 1) an anode current collector; 2) an anode layer disposed on the anode current collector; 3) a solid electrolyte layer disposed on the anode layer; 4) a cathode layer disposed on the solid electrolyte layer; 5) a cathode current collector disposed on the cathode layer; 6) an anode terminal part connected to the anode current collector; and 7) a cathode terminal part connected to the cathode current collector, wherein the anode layer comprises: a first region provided as a space between a side surface of the anode layer and a cross section spaced apart from the side surface by a predetermined distance; and a second region provided as a remaining part of the anode layer other than the first region, wherein: a content of a first binder in the first region is greater than a content of a second binder in the second region; and the anode terminal part is connected to the anode current collector in the first region. In certain preferred aspects. the anode current collector has a shape of a plate and the a cathode current collector has the shape of a plate.

In another aspect, the present disclosure may provide an all-solid-state battery including an anode current collector with a shape of a plate, an anode layer disposed on the anode current collector, a solid electrolyte layer disposed on the anode layer, a cathode layer disposed on the solid electrolyte layer, a cathode current collector disposed on the cathode layer with a shape of a plate, an anode terminal part connected to the anode current collector, and a cathode terminal part connected to the cathode current collector.

A term “shape of a plate” or “plate-shape” as used herein refers to a three-dimensional shape of a plate, sheet, film or a thin layer, which has a planar surface and a substantially reduced thickness (e.g., millimeter, micrometer, or nanometer scale) compared to a width or a length of the planar surface.

The anode layer may include (i) a first region provided as a space between a side surface of the anode layer and a cross section spaced apart from the side surface by a predetermined distance, and (ii) a second region provided as a remaining part of the anode layer other than the first region.

A content of a first binder in the first region may be greater than a content of a second binder in the second region.

The anode terminal part may be connected to the anode current collector in the first region.

An area of the solid electrolyte layer may be equal to or greater than an area of the anode layer, and an area of the cathode layer may be less than the area of the anode layer.

The first region may include an amount of about 4 wt % to 7 wt % of the first binder based on the total weight of the first region.

In a further preferred embodiment, the second region may include an amount of about 0.1 wt % to 3 wt % of the second binder based on the total weight of the second region.

Each first binder and the second binder may independently include one or more selected from the group consisting of styrene butadiene rubber, nitrile butadiene rubber, and butadiene rubber.

The anode layer may further include a reactive region configured to overlap the solid electrolyte layer and the cathode layer, and a non-reactive region provided as a remainder other than the reactive region.

A length of the first region may be about 50% to 75% of a distance from the side surface to the reactive region.

The length of the first region may be about 2 mm to 3 mm.

An adhesive strength between the first region and the anode current collector may be about 0.3 gf/mm to 0.5 gf/mm.

Also provided is a vehicle that includes the all-solid-state battery as described herein.

In another aspect, provided is a method of manufacturing the all-solid-state battery as described herein. The method includes a step of forming the anode layer by applying a first slurry on the first region of the anode current collector and applying a second slurry on the second region of the anode current collector.

The first slurry may suitably include the first binder, a first active material and a first solid electrolyte and the second slurry may suitably include the second binder, a second active material and a second solid electrolyte. The first slurry includes the first anode active material and the first solid electrolyte at a mass ratio of about 6:4 to 8:2 and the second slurry comprises the second anode material and the second solid electrolyte at a mass ratio of about 6:4 to 8:2.

In a further aspect, vehicles are provided that comprise one or more batteries as disclosed herein. The present vehicles suitably may be electric-powered.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary anode layer according to an exemplary embodiment of the present disclosure;

FIG. 3 shows the length of a first region of FIG. 2;

FIG. 4 shows an exemplary method of manufacturing an anode layer according to an exemplary embodiment of the present disclosure;

FIG. 5 shows that whether or not detachment of an anode layer according to Comparative Example occurs is observed with the naked eye;

FIG. 6 shows that whether or not detachment of an anode layer according to Example occurs s observed with the naked eye;

FIG. 7 shows adhesive strengths between the anode layers and anode current collectors according to Example and Comparative Example; and

FIG. 8 shows charge and discharge curves of all-solid-state batteries according to Example and Comparative Example.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

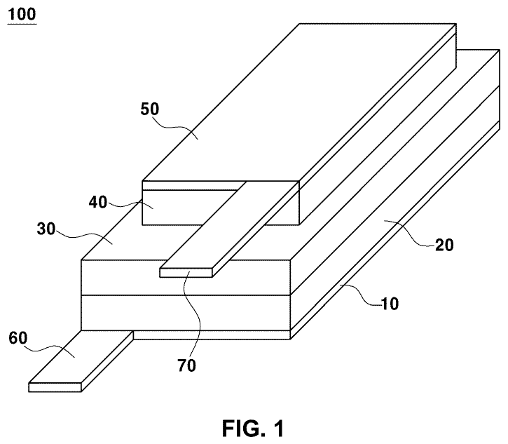

FIG. 1 shows an exemplary all-solid-state battery according to the present disclosure. In FIG. 1, an all-solid-state battery 100 may include an anode current collector 10, an anode layer 20 disposed on the anode current collector 20, a solid electrolyte layer 30 disposed on the anode layer 20, a cathode layer 40 disposed on the solid electrolyte layer 30, a cathode current collector 50 disposed on the cathode layer 40, an anode terminal part 60 connected to the anode current collector 10, and a cathode terminal part 70 connected to the cathode current collector 50.

The area of the solid electrolyte layer 30 may be equal to or greater than the area of the anode layer 20. Further, the area of the cathode layer 40 may be less than the area of the anode layer 20.

The anode current collector 10 may be a plate-shaped base material having electrical conductivity. The plate shape may mean a three-dimensional shape having at least two main surfaces opposing each other. Concretely, the anode current collector 10 may have the form of a sheet, thin film or foil.

The anode current collector 10 may include a material which does not react with lithium. Concretely, the anode current collector 10 may include at least one selected from the group consisting of nickel (Ni), copper (Cu), stainless steel, and combinations thereof.

The thickness of the anode current collector 10 is not limited to a specific value, and may be, for example, about 1 μm to 500 μm.

The anode terminal part 60 may include a metal plate electrically connected to the anode current collector 10. The shape of the anode terminal part 60 may be, for example, a rectangular plate shape. The width of the anode terminal part 60 is not limited to a specific value, and may be less than the width of the anode current collector 10.

The anode terminal part 60 may include a metal, such as nickel (Ni), or the like.

The anode terminal part 60 may be welded to the anode current collector 10. The welding position of the anode terminal part 60 is not limited to a specific position, and the anode terminal part 60 may be welded to one side surface or the edge of one main surface of the anode current collector 10. The welding method of the anode terminal part 60 is not limited to a specific method, and may be ultrasonic welding, spot welding, laser welding, or the like. Particularly, the anode terminal part 60 may be connected to the anode current collector 10 by ultrasonic welding.

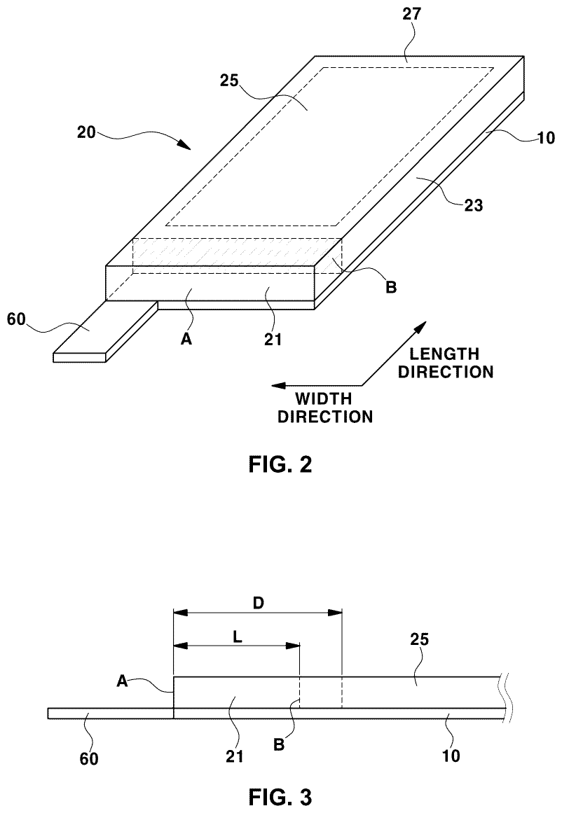

FIG. 2 shows the anode layer 20 according to an exemplary embodiment of the present disclosure. In FIG. 2, the anode layer 20 may have the form of a sheet having a predetermined width and length.

The anode layer 20 may include a first region 21 which is a space between a side surface A of the anode layer 20 and a cross section B spaced apart from the side surface A by a predetermined distance, and a second region 32 which is the remaining part of the anode layer 20 other than the first region 21. Concretely, the first region 21 may be a space between the side surface A of the anode layer 20 in the length direction and the cross section B spaced apart from the side surface A by a predetermined distance in the length direction.

The first region 21 may have a greater content of a binder than the second region 23. Concretely, a content of a first binder in the first region is greater than a content of a second binder in the second region. In order to prevent detachment between the anode current collector 10 and the anode layer 20 in a region adjacent to the anode terminal part 60 due to ultrasonic energy when the anode terminal part 60 is ultrasonically welded to the anode current collector 10, the content of the first binder in the first region 21 is increased.

Therefore, the anode terminal part 60 may be connected to the anode current collector 10 in the first region 21.

The first region 21 may include an amount of about 4 wt % to 7 wt % of the first binder, and the balance of an anode material, based on the total weight of the first region. The anode material may include an anode active material and a solid electrolyte in a mass ratio of about 6:4 to 8:2. When the content of the first binder in the first region 21 is less than about 4 wt %, adhesive strength between the first region 21 and the anode current collector 10 is reduced, and thus, detachment of the anode layer 20 may occur when the anode terminal part 60 is ultrasonically welded to the anode current collector 10. When the content of the first binder in the first region 21 is greater than about 7 wt %, the viscosity of slurry configured to form the first region 21 may be increased, and thus, it may be difficult to form the first region 21 through coating.

The second region 23 may include about 0.1 wt % to 3 wt % of the second binder, and the balance of the anode material, based on the total weight of the second region. The anode material may include the anode active material and the solid electrolyte in a mass ratio of about 6:4 to 8:2.

Each the first binder and the second binder each may independently include one or more selected from the group consisting of styrene butadiene rubber, nitrile butadiene rubber, and butadiene rubber.

The anode active material may suitably include a carbon-based active material, a silicon-based active material, or a combination thereof.

The carbon-based active material may suitably include natural graphite, artificial graphite, or the like.

The silicon-based active material may suitably include Si, SiOₓ (0<x<2), or the like.

The solid electrolyte may suitably include an oxide-based solid electrolyte, a sulfide-based solid electrolyte, or the like.

The oxide-based solid electrolyte may suitably include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like.

The anode layer 20 may suitably include a reactive region 25 configured to overlap the solid electrolyte layer 30 and the cathode layer 40, and a non-reactive region 27 which is the remainder other than the reactive region 25. The reactive region 25 may indicate a part of the anode layer 20, which lithium ions (Li+) released from the cathode layer 40 reach via the solid electrolyte layer 30 so as to cause an electrochemical reaction with electrons during charging. The area of the reactive region 25 may be substantially the same as the area of the cathode layer 40.

FIG. 3 shows a length L of the first region 21. The length L of the first region 21 may be about 50% to 75% of a distance D from the side surface A to the reactive region 25. Each of both the length L of the first region 21 and the distance from the side surface A to the reactive region 25 may indicate a straight distance from a starting point to an ending point in the length direction. When the length L of the first region 21 is less than about 50% of the distance D, the first region 21 is too short, and thus, detachment of the anode layer 20 may occur when the anode terminal part 60 is ultrasonically welded. When the length L of the first region 21 is greater than about 75% of the distance D, it may be difficult for the first region 21 not to invade the reactive region 25. Concretely, the length L of the first region 21 may be about 2 mm to 3 mm.

Adhesive strength between the first region 21 and the anode current collector 10 may be equal to or greater than about 0.3 gf/mm. The upper limit of the adhesive strength is not limited to a specific value, and may be equal to or less than about 0.5 gf/mm. Such adhesive strength may be a value measured by a universal testing machine (UTM). This will be described later.

The solid electrolyte layer 30 may be interposed between the anode layer 20 and the cathode layer 40, and may include a solid electrolyte having lithium ion conductivity.

The solid electrolyte may include an oxide-based solid electrolyte, a sulfide-based solid electrolyte, or the like.

The oxide-based solid electrolyte may suitably include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO; (x and y being positive numbers, and M being one of P, Si, Ge, B, Al, Ga and In), Li₁₀GeP₂S₁₂, or the like.

The cathode layer 40 may include a cathode active material, a solid electrolyte, a conductive material, a cathode binder, and the like.

The cathode active material may store and release lithium ions.

The cathode active material may suitably include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The solid electrolyte may include an oxide-based solid electrolyte or a sulfide-based solid electrolyte. Particularly, the sulfide-based solid electrolyte having high lithium ion conductivity may be used. The sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, without being limited thereto. The solid electrolyte included in the cathode layer 40 may be the same as or different from the solid electrolyte included in the solid electrolyte layer 30.

The conductive material may include carbon black, conductive graphite, ethylene black, graphene, or the like.

The cathode binder may include butadiene rubber, nitrile butadiene rubber, hydrogenated nitrile butadiene rubber, polyvinylidene fluoride, polytetrafluoroethylene, or the like.

The cathode current collector 50 may include a plate-shaped base material having electrical conductivity. The cathode current collector 50 may include aluminum foil.

The thickness of the cathode current collector 50 is not limited to a specific value, and may be, for example, about 1 μm to 500 μm.

The cathode terminal part 70 may include a metal plate electrically connected to the cathode current collector 50. The shape of the cathode terminal part 70 may be, for example, a rectangular plate shape.

The width of the cathode terminal part 70 is not limited to a specific value, and may be less than the width of the cathode current collector 50.

The cathode terminal part 70 may include a metal, such as aluminum (Al), or the like.

The cathode terminal part 70 may be welded to the cathode current collector 50. The welding position of the cathode terminal part 70 is not limited to a specific position, and the cathode terminal part 70 may be welded to one side surface or the edge of one main surface of the cathode current collector 50. The welding method of the cathode terminal part 70 is not limited to a specific method, and may be ultrasonic welding, spot welding, laser welding, or the like. Particularly, the cathode terminal part 70 may be connected to the cathode current collector 50 by ultrasonic welding.

The anode terminal part 60 and the cathode terminal part 70 may be formed at one end of the all-solid-state battery 100 in the same direction, as shown in FIG. 1, or may be formed in opposite directions.

### EXAMPLE

Hereinafter, the present disclosure will be described in more detail through the following examples. The following examples serve merely to exemplarily describe the present disclosure, and are not intended to limit the scope of the invention.

### Example

First slurry including about 4.4 wt % of the first binder and the balance of an anode material was prepared. Second slurry including about 2 wt % of the second binder and the balance of the anode material was prepared. Butadiene rubber was used as the first binder and the second binder. An anode active material and a sulfide-based solid electrolyte were used as the anode material.

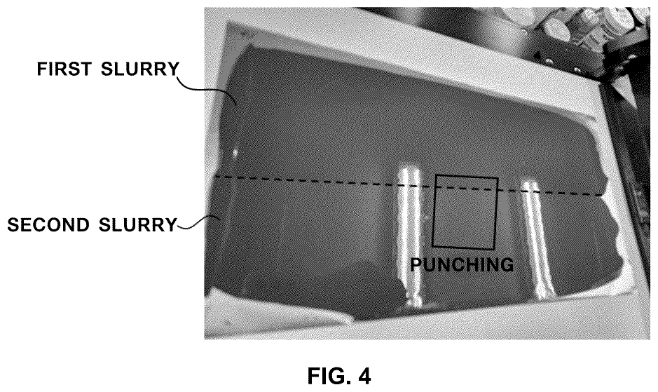

The first slurry and the second slurry were coated on a base material using a table coater, as shown in FIG. 4, and were dried. An anode layer was acquired by punching a dried resultant product so that the length of a first region was about 2 mm to 3 mm, as shown in FIG. 4.

After the anode layer was adhered to an anode current collector, an anode terminal part was connected to one side surface of the anode current collector by ultrasonic welding. Here, the anode terminal part was connected to the side surface of the anode current collector so that the first region is located at one side of the anode terminal part.

A solid electrolyte layer having the same size as the anode layer was stacked on the anode layer, and a cathode layer was stacked on the solid electrolyte layer. An all-solid-state battery was acquired by stacking a cathode current collector having a cathode terminal part welded thereto on the cathode layer.

### Comparative Example

Slurry including about 2 wt % of a binder and the balance of an anode material was prepared. Butadiene rubber was used as the binder. An anode active material and a sulfide-based solid electrolyte were used as the anode material.

The slurry was coated on a base material using a table coater, and was dried. An anode layer was acquired by punching a dried resultant product so that the anode layer had the same area as the anode layer according to Example.

An all-solid-state battery was manufactured in the same configuration and manner as in Example, except that the above anode layer according to Comparative Example was used.

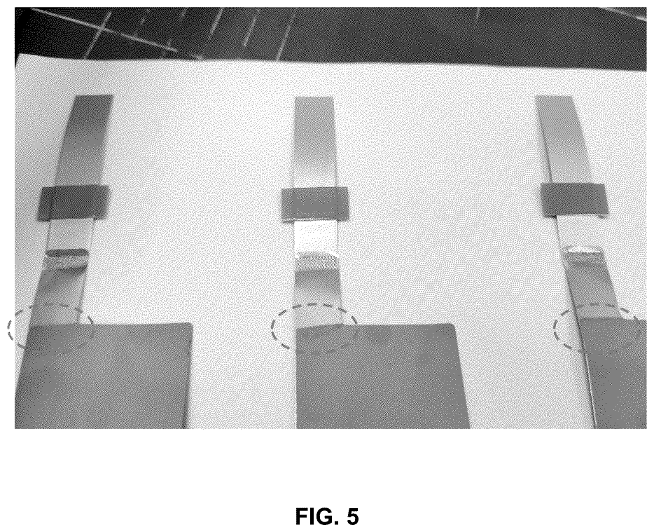

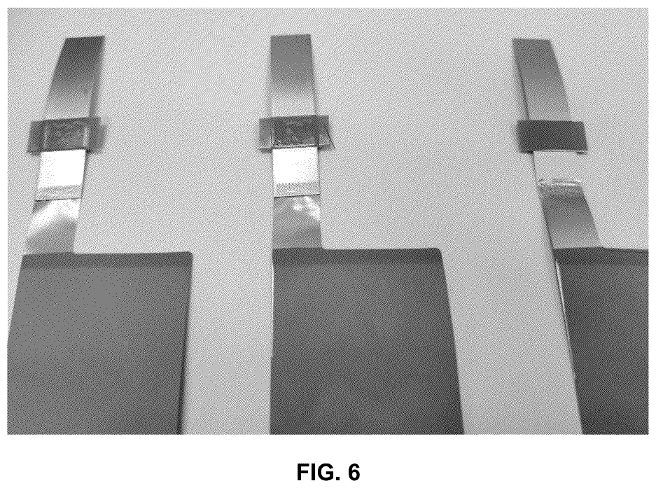

FIG. 5 shows that whether or not detachment of the anode layer according to Comparative Example occurs is observed with the naked eye. FIG. 6 shows that whether or not detachment of the anode layer according to Example occurs is observed with the naked eye. Detachment of the anode layer according to Comparative Example occurred during the process of ultrasonically welding the anode terminal part, but detachment of the anode layer according to Example did not occur.

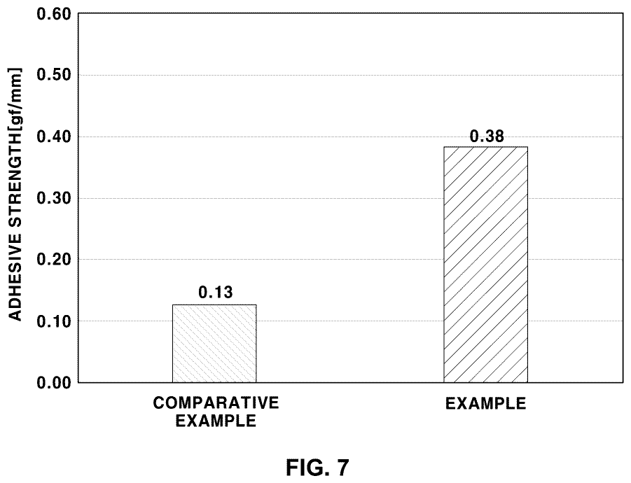

FIG. 7 shows adhesive strengths between the anode layers and the anode current collectors according to Example and Comparative Example. The anode layers and the anode current collectors according to Example and Comparative Example were put between PET films of about 100 μm in thickness, and were pressurized using a flat press at a temperature of about 60° C. and a pressure of about 6.5 MPa for about 1 second. Acquired resultant products were adhered to a slide glass, and were mounted on a holder of the UTM. Forces required to detach the anode layers and the corresponding anode current collectors from each other were measured by applying force at a speed of about 300 mm/min. As shown in FIG. 7, adhesive strength between the anode layer, concretely, the first region of the anode layer, and the anode current collector according to Example was about 0.38 gf/mm which is much greater than adhesive strength between the anode layer and the anode current collector according to Comparative Example.

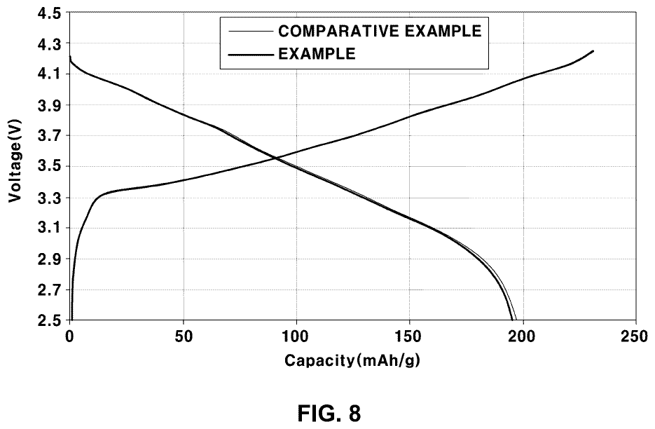

FIG. 8 shows charge and discharge curves of the all-solid-state batteries according to Example and Comparative Example. As shown in FIG. 8, even though the content of the binder in a predetermined region of the anode layer was increased, performance of the all-solid-state battery was not affected.

Consequently, according to various exemplary embodiments of the present disclosure, detachment of the anode layer due to energy of ultrasonic-welding may be solved without deterioration of performance of the all-solid-state battery.

As is apparent from the above description, according to various exemplary embodiments of the present disclosure, an all-solid-state battery which may prevent detachment in an anode while maintaining cell characteristics may be provided.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
an anode current collector;
an anode layer disposed on the anode current collector;
a solid electrolyte layer disposed on the anode layer;
a cathode layer disposed on the solid electrolyte layer;
a cathode current collector disposed on the cathode layer;
an anode terminal part connected to the anode current collector; and
a cathode terminal part connected to the cathode current collector,
wherein the anode layer comprises:
a first region provided as a space between a side surface of the anode layer and a cross section spaced apart from the side surface by a predetermined distance; and
a second region provided as a remaining part of the anode layer other than the first region,
wherein:
a content of a first binder in the first region is greater than a content of a second binder in the second region; and
the anode terminal part is connected to the anode current collector in the first region.

2. The all-solid-state battery of claim 1, wherein the anode current collector has a shape of a plate and the a cathode current collector has the shape of a plate.

3. The all-solid-state battery of claim 1, wherein:
an area of the solid electrolyte layer is equal to or greater than an area of the anode layer; and
an area of the cathode layer is less than the area of the anode layer.

4. The all-solid-state battery of claim 1, wherein the first region comprises an amount of about 4 wt % to 7 wt % of the first binder based on the total weight of the first region.

5. The all-solid-state battery of claim 1, wherein the second region comprises an amount of about 0.1 wt % to 3 wt % of the second binder based on the total weight of the second region.

6. The all-solid-state battery of claim 1, wherein each the first binder and the second binder independently comprises one or more selected from the group consisting of styrene butadiene rubber, nitrile butadiene rubber, and butadiene rubber.

7. The all-solid-state battery of claim 1, wherein:
the anode layer further comprises a reactive region configured to overlap the solid electrolyte layer and the cathode layer, and a non-reactive region provided as a remainder other than the reactive region; and
a length of the first region is about 50% to 75% of a distance from the side surface to the reactive region.

8. The all-solid-state battery of claim 1, wherein a length of the first region is about 2 mm to 3 mm.

9. The all-solid-state battery of claim 1, wherein adhesive strength between the first region and the anode current collector is about 0.3 gf/mm to 0.5 gf/mm.

10. A vehicle comprising an all-solid-state battery of claim 1.

11. A method of manufacturing an all-solid-state battery of claim 1, comprising:
forming the anode layer by applying a first slurry on the first region of the anode current collector and applying a second slurry on the second region of the anode current collector,
wherein the first slurry comprises the first binder, a first active material and a first solid electrolyte and the second slurry comprises the second binder, a second active material and a second solid electrolyte.

12. The method of claim 11, wherein the first slurry comprises the first anode active material and the first solid electrolyte at a mass ratio of about 6:4 to 8:2.

13. The method of claim 12, wherein the second slurry comprises the second anode material and the second solid electrolyte at a mass ratio of about 6:4 to 8:2.
